(19) United States
(12) Patent Application Publication
(10) Pub. No.: US 2006/0192442 A1
(43) Pub. Date: Aug. 31, 2006

(54) Z.E.E (zero emission engine)

(76) Inventor: Garrett Michael Smith, Anchorage, AK (US)

Correspondence Address: Garrett Smith, P.O. Box 220392, Anchorage, AK, 99522, US

(21) Appl. No.: 11/066,693

(22) Filed: Feb. 28, 2005

(51) Int. Cl. H02K 37/00

(52) U.S. Cl. 310/46

(57) ABSTRACT

The concept behind the ZEE (zero emission engine) is rather than using fossil fuel combustion it's using electronic controlled magnets for propulsion. On the first stroke or up stroke it's going to use positive and negative to pull the piston to the top of the stroke when it reaches the top of the stroke the computer is going to switch it to positive and positive to force the piston down. And with every stroke spinning the crankshaft turns the power generator to make it's own power. When the throttle is pressed the crank starts to turn at first using the power stored in the battery's the first rotation starts the power generator making it's own power and at the same time the throttle being pressed tells the computer to speed up the switching of the Electronic controlled magnets getting a faster Rpm ( rotations per minute) When the brake is pressed the computer tells the electronic controlled magnets to slow down the switching process to help slow down the vehicle.

### CROSS REFERENCE TO RELATED APPLICATIONS

No Related Applications found as Feb. 28, 2004

### STATEMENT REGARDING FED SPONSORED R & D

No Federal Sponsored R&D as of Feb. 28, 2004

### BACKGROUND OF THE INVENTION

In June of 2004 I determined that using magnets Rather than fossil fuel for engine propulsion could result in an electric motor having the same if not better performance.

### BRIEF SUMMARY OF THE INVENTION

ZEE engine converts power produced using force derived from electronically controlled magnets for propulsion. The input from throttle and brake tells the computer to increase or decrease R.P.M (rotations per minute)

### BRIEF DESCRIPTION OF THE DRAWINGS

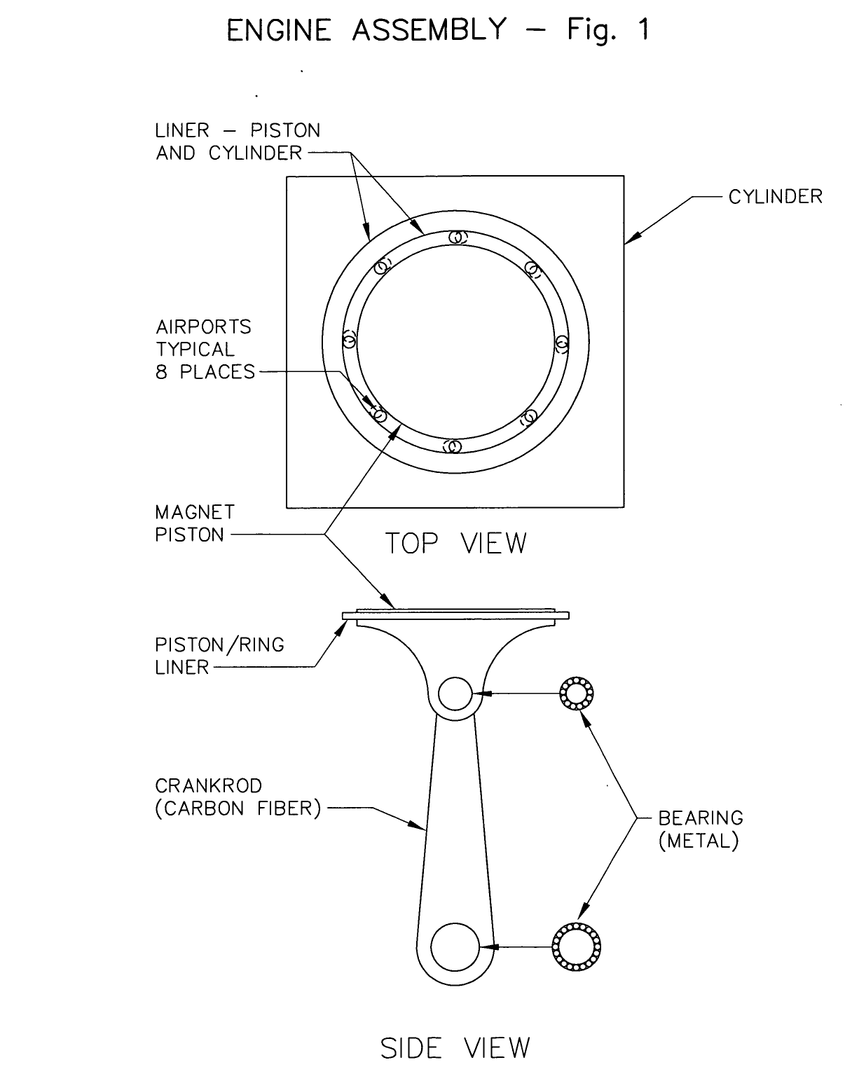

Engine Assembly—FIG. 1

This page illustrates the top and side view of the Magnetic piston, Cylinder liner, Crank rod, Bearings, Airports located on the piston ring liner, and a part of the Engine block labeled the Cylinder. It also lists the materials used to make the parts.

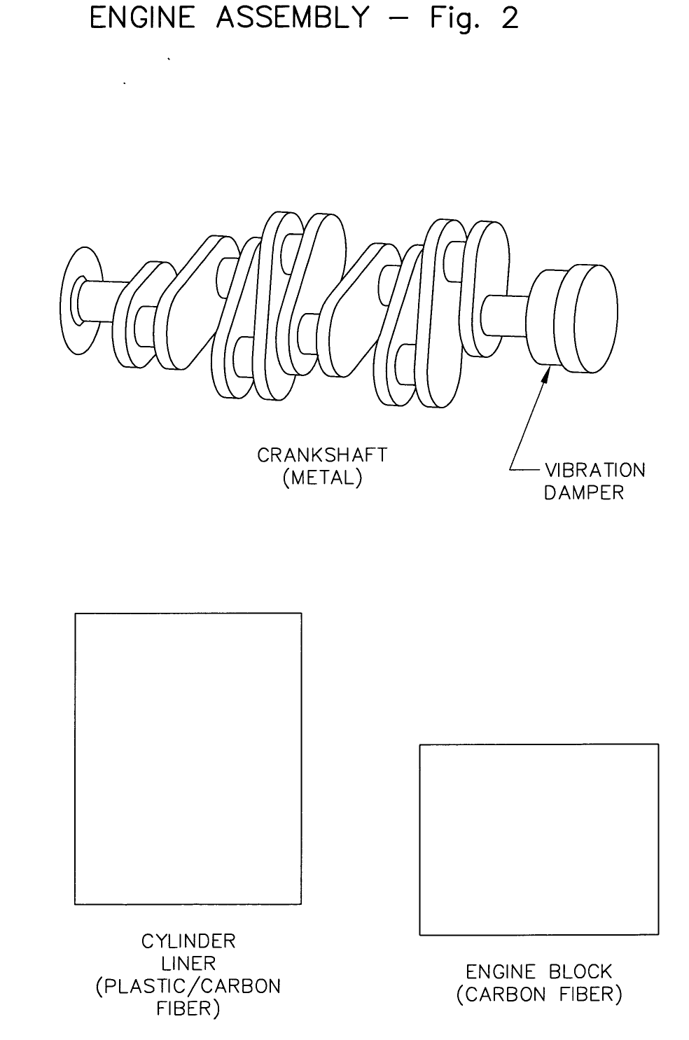

Engine Assembly—FIG. 2

This page illustrates the Crank and Cylinder liner and Engine block and details materials used to make the parts

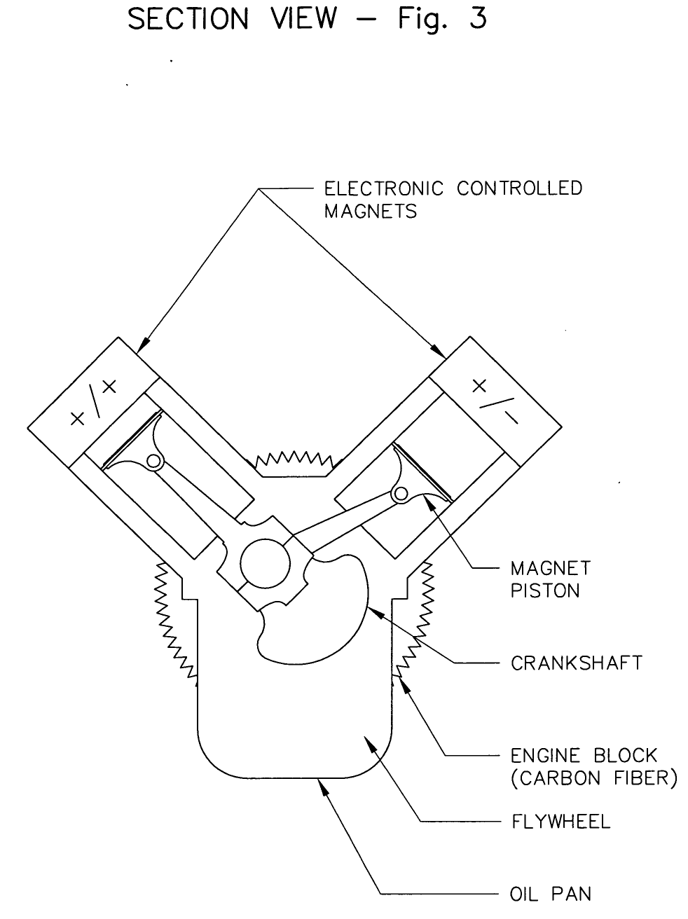

Section View—FIG. 3

This page shows the Engine's operation process, parts shown include Electronic Controlled Magnets, Magnet piston, Crankshaft, Engine block, Fly wheel and oil pan.

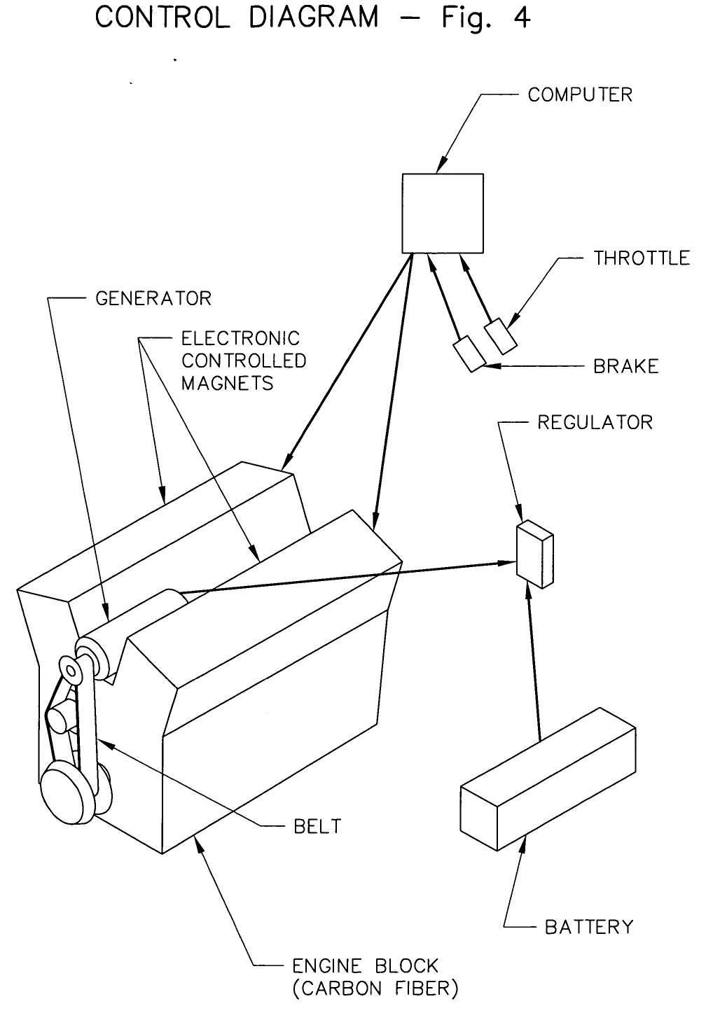

Control Diagram—FIG. 4

This page labels, all components of demonstrates the power flow through the engine cycle. A computer will control the positive/negative charges of magnets as detailed in the Section View to produce power necessary for propulsion. Depressing the throttle will tell the computer to increase RPM. While depressing the brake will tell the computer to decrease RRM. Increases & decreases of RPM will be proportioned to amount of force applied to the throttle & brake, respectively.

1. The design and operation of the engine using converted power produced using magnets.

2. Using carbon fiber for the block and crank rods
